(19) United States
(12) Patent Application Publication
(10) Pub. No.: US 2004/0232809 A1
(43) Pub. Date: Nov. 25, 2004

(54) Laundry sorter for young children

(76) Inventor: Judith Buchman-Ziv, Tel-Aviv (IL)

Correspondence Address: William R. Evans, Ladas & Parry, 26 West 61 Street, New York, NY, 10023, US

(21) Appl. No.: 10/860,250

(22) Filed: Jun. 3, 2004

(30) Foreign Application Priority Data
May 6, 2003 (IL) 156332

(51) Int. Cl. A47G 29/14

(52) U.S. Cl. 312/234.1; 312/293.2

(57) ABSTRACT

A multi-compartmented piece of furniture adapted for sorting clothing of young children and comprising a rigid cabinet structure and a plurality of storing compartments, wherein an outer surface of the compartments includes indications thereon for sorting of the clothing in a manner recognizable by young children.

### FIELD OF THE INVENTION

This invention relates to furniture for laundry, particularly furniture suited to children for sorting and storing laundry.

### BACKGROUND OF THE INVENTION

With fathers as well as mothers often away from their children due to work or for other reasons, children are encouraged to be more independent and learn life skills at a younger age. An example of one of these life skills is the sorting of dirty laundry and placing clean laundry in its proper place in a dresser or chest of drawers.

At an early age, e.g. as early as the toddler stage, children can be and are taught to differentiate between colors and objects, whether at home or in day care. For that purpose there is a plethora of toys that teach children basic size and space perception as well as to differentiate colors.

In parallel, parents and pre-school teachers often encourage children to assist them in household chores, as a sort of game. In day care centers, children often have assigned compartments for storing their personal items and for teaching them the importance of looking after those belongings. It is well known that teaching children responsibility in the home or at pre-school at a young age assists them in their personal development and ability to take on personal responsibility at a later age.

A variety of laundry cabinets and sorters are available. Presently available laundry sorters or clothes hampers are typically made of cloth or nylon. They are often attached or attachable to a trolley allowing the hampers to be moved to advantageous locations within or a room or for transporting to a washing area.

Laundry sorters may comprise two bags where one is white and one is colored, such as blue, for indicating that colored laundry is to be placed therein. There are also decorative hampers, which may be stackable, and furthermore may have animal or other appropriate motifs, suitable for children's rooms.

Relevant prior art includes U.S. Design Pat. No. 336,696, “Pre-sort Clothes Hamper” to Bateman et al, which discloses a rectangular cabinet with three compartments, each compartment having an picture on its outside surface of clothing articles such as a shirt, pair of trousers, skirts, etc.

Additional prior-art of some relevance is provided in U.S. Pat. Nos. 2,625,973, 3,995,924 and 5,102,208 which all disclose clothes sorters comprising separate compartments which may be useful for sorting clothes of different colors or types.

However, all of the above disclosures are not particularly suited for young children for reasons such as: the indications for clothes types/colors are in written form, are internal to the sorter and may be difficult for a small child to see therein, are of an upright design (i.e. inconveniently tall for young children, especially toddlers to use) and so forth, or comprise a combination of such drawbacks, etc.

### SUMMARY OF THE INVENTION

Accordingly, it is an object of the present invention to provide furniture that assists in teaching young children to sort their own laundry according to color and or type, and furthermore in a game-like manner.

The term compartment hereinafter in the specification and claims is meant to include a broad category of furniture storage areas including compartments, cabinets, drawers, shelves, and the like.

According to the present invention there is provided a multi-compartmented piece of furniture adapted for sorting and/or storing laundry/clothing of the young children and comprising a rigid cabinet structure and a plurality of storing compartments, wherein the outer surface of the compartments includes indications thereon for sorting and/or storing of the laundry/clothing in a manner recognizable by young children.

For sake of clarity, the terms sorting and storing will be collectively referred to in the claims as sorting, and the terms laundry and clothing will be collectively referred to in the claims as clothing.

Although the furniture is envisioned to be used primarily for the sorting and/or storing of dirty laundry, in particular embodiments, the present invention could be used as dresser furniture for storing clean laundry or clothing, with little or no need for change in design. However, for drawers of dresser furniture, the present invention could be designed to be particularly suited for particular clothing (e.g. types—trousers, shirts, sweaters, colors, etc.).

In many cases using the invention to store clean clothes, i.e. as a dresser, by children of toddler age would typically occur only after a parent or caretaker has prepared the clothes, for example, by folding and arranging them. However, children of post-toddler age would not necessarily need such help and would therefore potentially be encouraged to learn the additional skills of folding and/or arranging their own clothes. The present invention would provide an indication(s) for assisting in deciding where certain clothes are to be located (by color, etc).

The indication(s), visible and recognizable to the young child, may be for example: a picture of a particular scene of various colors (rainbow, sun, etc), a jigsaw puzzle comprised of arbitrary colors, a picture puzzle of a particular scene or puzzle wherein the pieces are items of clothing—the pieces being of at least one color other than white as well as including white pieces for the “white's” draw, etc.

According to one embodiment, the puzzle board is readily mountable on the compartments' external surfaces, and can be changed according age group (i.e., more complex puzzle with more pieces for older age group).

According to another embodiment, the puzzle board is the outer surface of the compartment (for example, formed of plastic pieces) and also interchangeable with a different puzzle board according to age group.

According to yet another embodiment, the indications on the outer surface of the compartment comprise stickers with the corresponding scene, color, etc. Accordingly, the stickers can be removed and replaced with other stickers, thereby allowing diversification of the scene, etc., for variety or for changing the scene to suit children of different ages or interests. Alternatively, a new sticker may be placed one on top of the former.

According to yet a further embodiment, the indications on the outer surface of the compartment are comprised of an outline of a scene, colors, etc., whereby an individual may then fill in the colors as desired. The outline may further include numbers or other indications as a recommendation as to which colors are suitable for the given scene, etc.

### BRIEF DESCRIPTION OF THE DRAWINGS

In order to understand the invention and to see how it may be carried out in practice, particular embodiments will now be described, by way of non-limiting examples only, with reference to the accompanying drawings, in which:

FIG. 1 is a perspective view of a laundry sorter for children according to an embodiment of the present invention; and

FIG. 2 is a perspective view of laundry sorters for children according to another embodiment of the present invention; and

FIG. 3 is a perspective view of laundry sorters for children according to still another embodiment of the present invention.

FIG. 4 is a front view of stickers for providing indications on laundry sorters for children according to yet another embodiment of the present invention.

### DETAILED DESCRIPTION OF THE INVENTION

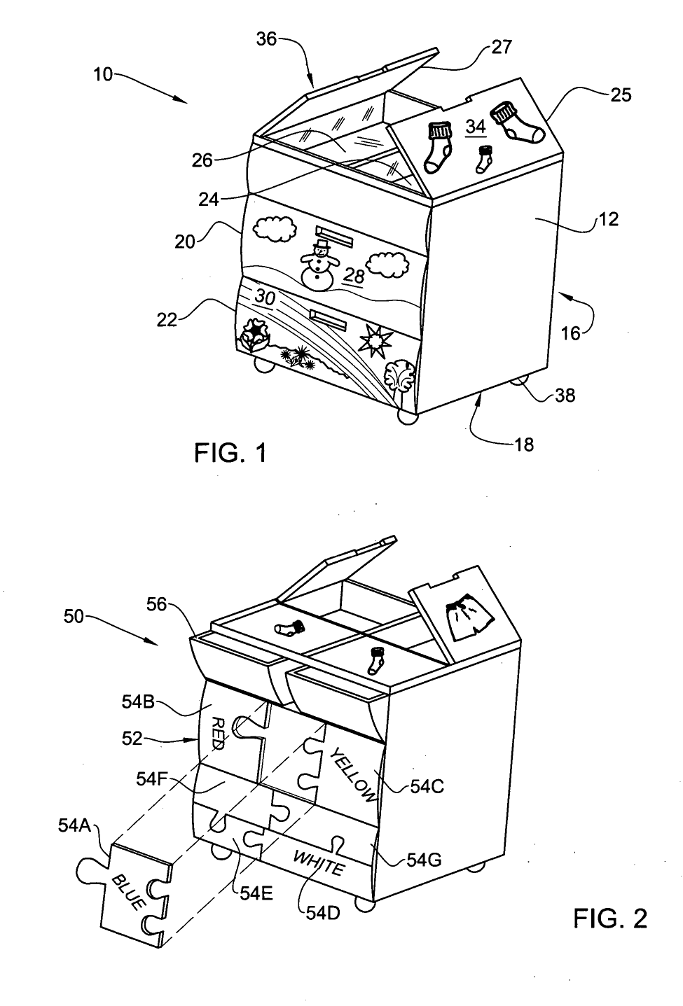

Referring first to FIG. 1 of the drawings, there is shown a piece of laundry sorter furniture, generally designated 10, for use in sorting and/or storing dirty laundry or alternatively for sorting and/or storing clean laundry (clothing, linens, etc.).

The sorter 10 is a cabinet, made for example of wood or plastic material, with side walls 12 and 14 (only one side wall 12 visible in FIG. 1), a rear wall 16 and a bottom wall 18. The sorter 10 is multi-compartmented and comprises a first drawer 20 and a second drawer 22 as well as a first compartment 24 having an upper upwardly opening door 25 and a second compartment 26 having an upper upwardly opening door 27.

The first drawer 20 is shown with a design on its outer surface 28 comprising white puffy clouds and a snowman, thereby intended to indicate that white clothes are to be placed therein. The second drawer 22 is shown having a rainbow and colorful flowers on its outer surface 30, thereby intended to indicate that colored clothes are to be placed therein.

The sorter 10 could optionally comprise more drawers of such a nature being usable and suitable for further classification of clothing, for example, colored short-sleeved shirts, wherein a design on an outer surface of such a drawer could have thereon short-sleeved shirts of various colors, etc. Another drawer could be intended for white undershirts, thus designs of white undershirts would appear on an outside surface of such a drawer.

The first compartment 24 and second compartment 26 are, in this embodiment, intended for a toddler to place socks therein and for this purpose sock designs appear on the outer surfaces 34 and 36 (not seen), respectively, of the compartments. The first compartment 24 could therefore have, for instance, white socks appearing thereon and the second compartment 26 could have colored socks appearing thereon. Alternatively, there could be additional compartments for further classification of sock colors and/or types. In this regard, the sorter 10 could further comprise additional drawers/compartments for clothing articles not mentioned, such as gloves, underwear, and so forth.

The sorter 10 is fitted with casters 38 that facilitate relocation of the sorter within a toddler's room, and if appropriate, for transporting the sorter to and within a laundering area. Additionally, the sorter 10 may comprise bags (not shown) which can be designed to line the inside of the drawers 20 and 22 and compartments 24 and 26 to facilitate carrying of dirty clothes/linens to a laundering area. For this purpose the bags and drawers/compartments may comprise any of a variety of attachment arrangements such as corresponding hook and loop fasteners (Velcro™) or snap fitting connectors, et cetera, with the stipulation that the arrangements be child-safe and manipulatable by a child, for removably attaching the bags to the inside of the drawers/compartments. The bags can be of various designs including mesh material.

FIG. 2 shows another embodiment in which a sorter 50 illustrates various possible modifications to the design of a piece of furniture for sorting and storing toddler's clothing and/or dirty laundry according to the present invention.

In the embodiment of FIG. 2, indications for directing a toddler to place clothes of certain types/colors into particular drawers are in the form of a puzzle 52 comprising variously shaped puzzle pieces 54A-54G. The pieces can have various indications and for example may be of a particular color and/or may have written thereon the name of a color—preferably in the color corresponding to the name. Thus, for example, one or more of the puzzle pieces 54A-54G could have the word red written thereon in a red color or the piece may be simply appear with a red color or the piece may be of a predominantly red color and have the word red written thereon.

Further options for compartments comprising puzzle pieces include the possibility, for example, that various puzzle pieces 54A-54G are available corresponding to different levels or ages of the children/toddlers. Thus, a puzzle scene could be comprised of a greater number of puzzle pieces 54A-54G with shapes appropriate for a child with a higher level of puzzle arranging skill. The puzzle pieces could alternatively make up other designs, such as the rainbow plus flowers and clouds plus snowman scene as shown in FIG. 1.

Optionally, there could be provided colorful and white pieces being magnetic pieces, or fitted with other fastening means such as hook and loop fasteners (not shown) for attaching to a drawer front. These pieces could comprise scenes such as those described in relation to FIG. 1 and the like, or of clothing articles.

Alternatively, the indications on the outer surface of the compartment comprise a sticker 70 or a combination of stickers 72A and 72B, (FIG. 4) with the corresponding predetermined scene, color, etc. The stickers can be removed and replaced with other stickers, thereby allowing diversification of the scene, etc., for variety or for changing the scene to suit children of different ages or interests. Alternatively, a new sticker may be placed one on top of the former.

By another alternative, the indications on the outer surface of the compartment are comprised of an outline (not shown) of a scene, colors, etc., whereby an individual may then fill in the colors as desired. The outline may further include numbers or other indications (such as words/colors), as a recommendation as to which colors are suitable for the given scene, etc.

Further illustrated in FIG. 2 is the option of the sorter 50 comprising at least some drawers being tiltable such as tilt-out drawers 56, which can be easier and more convenient for young children to access. Alternatively, a compartment may be a shelf with a tiltable door. It is however appreciated that various modifications and embodiments are possible, e.g. side and back drawers, side-by-side doors, removable drawers or compartments fitted with suitable handles, etc.

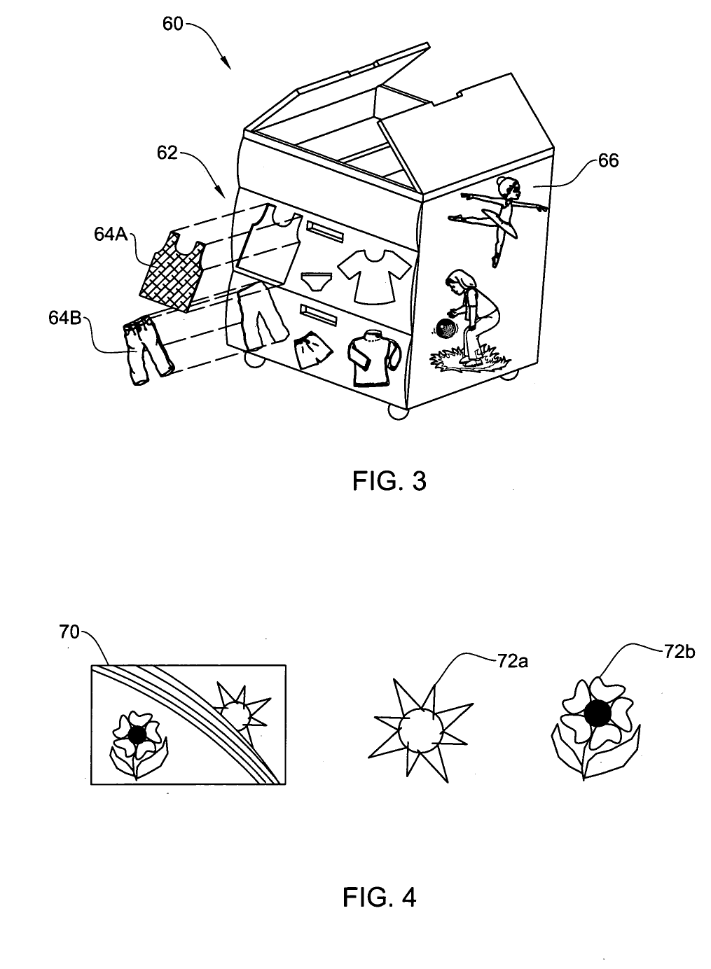

To illustrate a modification to the embodiment described in relation to FIG. 2, in FIG. 3 there is shown a laundry sorter 60 with an alternative puzzle 62 comprising various pieces, such as pieces 64A and 64B, depicting various articles of clothing—whose colors can further be indicated.

FIG. 3 further illustrates an additional option, wherein the side wall(s) 66 are used for a game-like purpose wherein it is used as a magnetic board, marker-board (such as a white board, chalkboard, etc.), a stick-on surface for example having hook and loop fasteners for receiving dolls, puzzle pieces, and the like.

It should be understood that there are various laundry sorters for young children devisable according to the present invention and that the above descriptions are merely explanatory. Thus, the laundry sorters can be embodied in a variety of aspects falling within the scope of the present invention, mutatis mutandis.

1. A multi-compartmented piece of furniture adapted for sorting clothing of young children and comprising a rigid cabinet structure and a plurality of storing compartments, wherein an outer surface of the compartments includes indications thereon for sorting of the clothing in a manner recognizable by young children.

2. The furniture according to claim 1, wherein the furniture teaches young children to sort and store clothing in appropriate drawers in a game-like fashion.

3. The furniture according to claim 1, wherein the clothing is dirty laundry.

4. The furniture according to claim 1, wherein the clothing is clean clothing.

5. The furniture according to claim 1, wherein the indications comprise a colorful illustration for indicating that colored clothing is to be placed in a compartment and a scene comprising essentially white illustrations for indicating that white clothing is to be placed in a compartment.

6. The furniture according to claim 1, wherein the indications are composed of words written in colors.

7. The furniture according to claim 1, wherein the indications are composed of puzzle pieces.

8. The furniture according to claim 7, wherein the puzzle pieces have words written in colors thereon.

9. The furniture according to claim 7, wherein the puzzle pieces are pieces of various colors.

10. The furniture according to claim 7, wherein the puzzle pieces are attached by hook and loop fasteners.

11. The furniture according to claim 7, wherein the puzzle pieces are attached by a snap-fitting arrangement.

12. The furniture according to claim 7, wherein the puzzle pieces are attached by a magnetic arrangement.

13. The furniture according to claim 1, wherein the indications comprise illustrations of recognizable clothing articles.

14. The furniture according to claim 1, wherein the indications are formed by stickers, which are removably or non-removably attachable to the furniture.

15. The furniture according to claim 1, wherein the indications are formed by outlines, which require filling in with suitable colors to complete a desired scene or color.

16. The furniture according to claim 15, wherein the outline comprises indications to indicate an appropriate scene or color to facilitate the filling in.

17. The furniture according to claim 7, wherein the puzzle pieces are in the shape of recognizable clothing articles.

18. The furniture according to claim 1, wherein the furniture includes separate compartments for socks.

19. The furniture according to claim 1, wherein the furniture includes separate compartments for underwear.

20. The furniture according to claim 1, wherein the at least some of the compartments are closeable by front door-portions that tilt out.

21. The furniture according to claim 1, wherein the furniture further comprises bags designed to line the compartments.

22. The furniture according to claim 21, wherein the bags are removably attached to corresponding compartments.

23. The furniture according to claim 1, wherein the furniture further comprises a marker board.

24. The furniture according to claim 1, wherein the furniture further comprises a magnetic board.

25. A multi-compartment piece of furniture for young children adapted for sorting and/or storing laundry/clothing of the young children comprising (a) side walls, a rear wall and a bottom wall; and, (b) drawers, wherein the outer surface of the drawers include indications thereon for sorting and/or storing of the laundry/clothing in a manner recognizable by young children.

26. For a multi-compartmented piece of furniture as described in claim 1, a sticker or set of stickers adapted for providing indications on said furniture for sorting of the clothing in a manner recognizable by young children.
